(19) United States
(12) Patent Application Publication
(10) Pub. No.: US 2026/0063175 A1
(43) Pub. Date: Mar. 5, 2026

(54) DEVICE MOUNTABLE IN A HOLLOW SENSORIZED ROLLER AND ASSOCIATED HOLLOW SENSORIZED ROLLER AND ROLLER BEARING

(71) Applicant: AKTIEBOLAGET SKF, GOTEBORG (SE)

(72) Inventors: Andreas Clemens VAN DER HAM, Warnsveld (NL); Kishor Kamalakar POWAR, Bangalore (IN); Alexandre André Roland TAILLEPIED, Fondettes (FR)

(21) Appl. No.: 19/312,741

(22) Filed: Aug. 28, 2025

(30) Foreign Application Priority Data
Sep. 4, 2024 (IN) 202441067016

(51) Int. Cl. F16C 41/00; F16C 19/36

(52) U.S. Cl. CPC F16C 41/00; F16C 19/364; F16C 2233/00

(57) ABSTRACT

A device configured to be mounted in an axial central through bore of a hollow sensorized roller includes a sensor module, a power module and an adapter connecting the power module and the sensor module. The sensor module includes a tubular housing, and the power module includes a housing and the adapter has a central portion in axial contact with a first end of the tubular housing of the sensor module and a mounting base onto which is mounted the housing of the power module. A non-circular projection extends from the central portion of the adapter into a complementary opening in the tubular housing of the sensor module to prevent relative rotation of the housing of the sensor module relative to the adapter.

### CROSS-REFERENCE

This application claims priority to Indian patent application no. 202441067016 filed on Sep. 4, 2025, the contents of which are fully incorporated herein by reference.

### TECHNOLOGICAL FIELD

The present disclosure is directed to the monitoring of rolling bearing and more particularly to a hollow sensorized roller for monitoring a rolling bearing and a device mounted in the hollow sensorized roller.

### BACKGROUND

It is known to implement a sensorized roller in a rolling bearing to perform condition monitoring of the rolling bearing. The sensorized roller comprises a housing enclosing a sensor module including measurement devices for measuring deformation of the roller and electronics for processing a deformation signal from the measuring devices and an antenna for wirelessly transmitting the processed deformation signal to an external receiver.

To supply the measurement devices with electrical power, the housing further encloses a harvesting module to generate electricity from movements of the roller and providing the electricity to the measurement devices. The harvesting module comprises an electrical generator generating electrical power from the rotation of the sensorized roller.

In order to ensure proper functioning of the sensorized roller, the harvesting module has to be robustly secured to the sensor module.

### SUMMARY

Consequently, the present disclosure provides a device that contains a harvesting module which device is robustly secured to the module.

According to an aspect, a device intended to be mounted in an axial central through bore of a hollow sensorized roller is disclosed.

The device includes a sensor module, a power module, an adapter supporting the power module and the sensor module, and anti-rotation means. The sensor module comprises a tubular housing and the power module comprises a tubular housing having an end cap. The adapter has a central portion in axial contact with a first end of the housing of the sensor module and a mounting base onto which is mounted the tubular housing of the power module. The adapter also includes an end portion having a shape and that is insertable into an opening of the tubular housing of the sensor module having a complementary shape to avoid relative rotation between the sensor housing and the adapter.

The adapter thus permits to robustly secure the power module to the sensor module in a removable manner and to simplify the mounting of the hollow sensorized roller.

Advantageously, the end portion of the adapter has a non-circular shape and protrudes from the central portion of the adapter. Preferably, the housing comprises securing means configured to axially secure the adapter and the tubular housing of the sensor module. Preferably, the securing means comprises at least first and second pins, a first end of a first pin being inserted into a first lateral face of the non-circular part and a first end of a second pin being inserted into a second lateral face of the non-circular part, the second lateral face being opposed to the first lateral face, the second end of the first and second pins being inserted into the tubular housing of the sensor module.

Advantageously, the housing further comprises fixing means to secure the mounting base and the end cap of the power module.

Preferably, the mounting base of the adapter comprises a circumferential surface onto which is mounted an end of the tubular housing of the power module, the fixing means comprising a first set of through-holes in a lateral face of the tubular housing of the power module, a second set of holes in the circumferential surface and a plurality of screws, each screw passing through one of the through-holes of the first set and being engaged in one of the holes of the second set.

Advantageously, the adapter comprises an axial through-hole inside which a wire passes through to electrically connect the power module and the sensor module. Preferably, the mounting base of the adapter comprises a first bore configured to house a first bearing for supporting a shaft of the power module.

According to another aspect, a hollow sensorized roller for a rolling bearing is proposed. The rolling bearing comprises a roller body having an axial central through bore and a device as defined above, the device being fitted within the through axial central bore of the roller body. Preferably, the hollow sensorized roller further comprises an antenna module integrated in the housing of the sensor module.

According to another aspect, a rolling bearing is proposed. The rolling bearing comprises a stationary ring and a rotatably ring capable of rotating concentrically relative to one another, and at least one row of rolling elements interposed between a first raceway and a second raceway respectively provided on the first and second rings, one rolling element being a hollow sensorized roller as defined above.

### BRIEF DESCRIPTION OF THE DRAWINGS

Other advantages and features of the disclosure will appear on examination of the detailed description of embodiments, in no way restrictive, and the appended drawings in which:

FIG. 1 is a sectional view of a roller bearing according to an embodiment of the present disclosure.

FIG. 2 is an exploded perspective view of a hollow sensorized roller according to an embodiment of the disclosure.

FIG. 3 is a perspective view, partly in section, of a housing of the hollow sensorized roller of FIG. 2.

FIG. 4 is a sectional elevation view of the hollow sensorized roller of FIG. 2.

FIG. 5 is a perspective view of an adapter of the housing of FIG. 3.

FIG. 6 is a perspective view of an adapter of the housing of FIG. 6.

### DETAILED DESCRIPTION

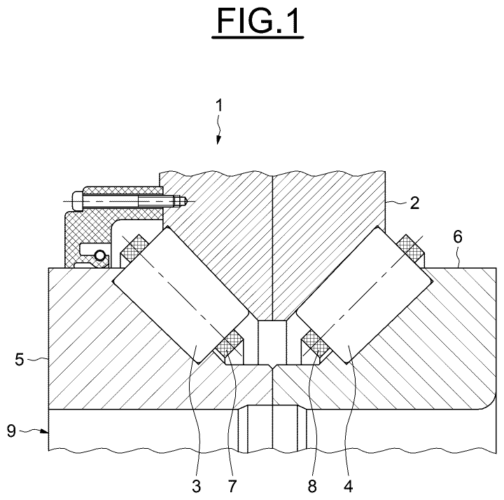

Reference is made to FIG. 1 which represents schematically an example of a roller bearing 1. the bearing 1 is a tapered roller bearing and comprises a stationary outer ring 2 having conical first and second outer raceways for a first row 3 and a second row 4 of rolling elements comprising tapered rollers. The bearing further comprises a rotatable ring formed from a first inner ring 5 and an axially adjacent second inner ring 6 which have respective conical first and second inner raceways for the first and second roller rows 3, 4. In addition, the bearing 1 further comprises a first cage 7 and a second cage 8 for retaining the rollers of the first and second roller sets respectively. Typically, the cages may be formed from segments that abut each other in circumferential direction.

To provide the necessary stiffness and ensure a long service life, the bearing is preloaded. The axial position of the rotatably rings 5, 6 relatives to the stationary ring 2 is set such that the first and second roller sets 2, 4 have a negative internal clearance. In variant, the bearing 1 is a spherical roller bearing or a cylindrical roller bearing and is not preloaded.

In the depicted bearing, at least one of the rolling elements in either of the first and second roller rows 3, 4 is replaced with a hollow sensorized roller. A shaft 9 is surrounded and fixed to the rotatably rings 5, 6.

The rolling bearing 1 comprises tapered rollers. In another embodiment, the rolling bearing 1 may comprise other type of rolling elements, for example cylindrical rollers or spherical rollers. The rolling bearing 1 may also comprise only one row of rolling elements or more than two rows of rolling elements, the number of cages being determined according to the number of rows. The rolling bearing 1 comprising a row of rolling elements comprises a unique inner ring. In another embodiment, the outer ring 2 is the rotatably ring and the inner rings 5, 6 are the stationary rings.

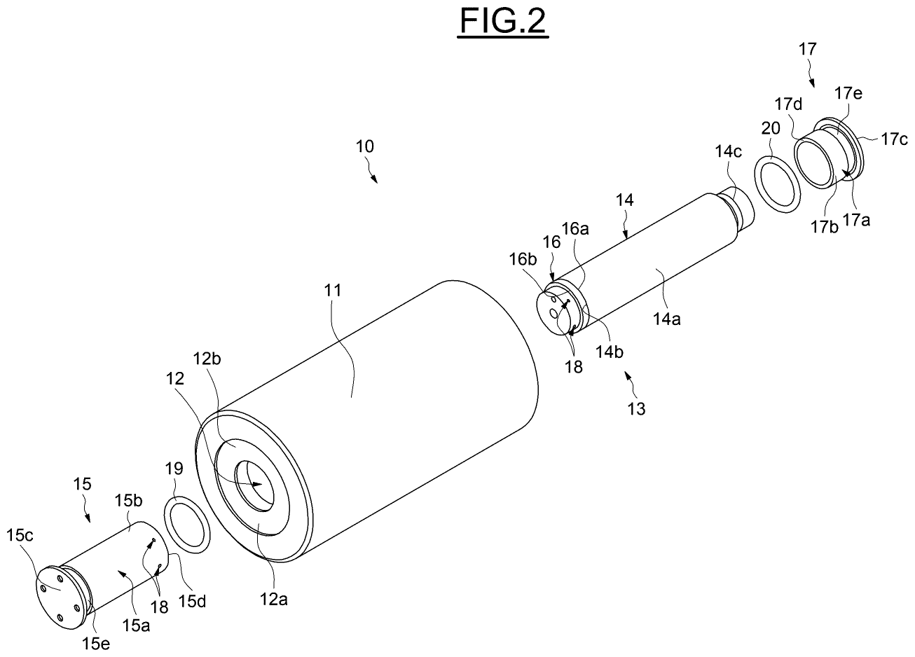

FIG. 2 illustrates schematically an example of the hollow sensorized roller 10. The hollow sensorized roller 10 comprises a roller body 11 comprising an axial central through bore 12 and a device 13 within the central bore 12 that extends through the roller body 11.

Each end of the through axial central bore 12 comprises an axial centering portion 12a, a conical portion 12b and a radial shoulder (not represented). The conical portion 12b extends obliquely outward from a first end of the centering portion 12a, and the radial shoulder extends radially inwards from a second end of the centering portion 12a.

The device 13 includes a sensor module 14, a power module 15, an adapter 16 supporting the power module 15 and the sensor module 14 and an end cap 17. The sensor module 14 comprises a tubular housing 14a, and the power module 15 comprises a tubular housing 15a inserted into a first end of the through axial central bore 12 of the roller body 11.

A first annular sealing element 19 is interposed between the housing 15a of the power module 15 and the bore 12 of the roller body 11.

The sensor module 14 is formed from two semi-cylindrical housing halves which are held together axially by the end cap 17 and the adapter 16. Screws and dowel pins (not represented) connect together radially the two semi-cylindrical housing halves.

The sensor module 14 houses at least one sensor (not represented on FIG. 2) for measuring parameters relating to the condition of the hollow sensorized roller. The sensor 14 is secured to the tubular housing 14a of the sensor module 14 and comprises for example a load sensor for measuring a load distribution across the hollow sensorized roller. The sensor module 14 further houses an antenna (not represented) secured to the tubular housing 14a of the sensor module 14. The sensor module 14 may further house a wireless transmitter (not represented) connected to the antenna to transmit the measurements of the sensor to a processing device (not represented) located outside the bearing for processing the measurements.

The housing 15a of the power module 15 comprises a cylindrical body 15b and an end cap 15c (first end cap) extending radially outward from the cylindrical body 15b. The first annular sealing element 19 is radially interposed between the cylindrical body 15b of the housing 15a and the bore 12 of the roller body 11 and axially interposed between the end cap 15c of the housing 15a and a shoulder at the first end of the bore 12 of the roller body 11.

The adapter 16 has a central portion 16a in axial contact with a first end 14b of the tubular housing 14a of the sensor module 14. The adapter 16 also has a mounting base 16b onto which is mounted a first end 15b of the housing 15a of the power module 15.

The end cap 15c of the housing 15a is secured to or formed integrally with the second end of the cylindrical body 15b of the housing 15a. A groove 15e is formed on the cylindrical body 15b of the housing 15a of the power module 15. The first annular sealing element 19 is located partly inside the groove 15e.

The adapter further includes a non-circular projection 26 extending from the central portion of the adapter 16 that is received into a complementary opening in the tubular housing 14a of the sensor module 14 to prevent rotation of the tubular housing 14a relative to the adapter 16.

The device 13 further comprises fixing means 18 to secure the mounting base 16b and the first end 15b of the housing 15a of the power module 15.

The end part 17 comprises an end cap 17a inserted into a second end of the bore 12 of the roller body 11. A second annular sealing element 20 is interposed between the end cap 17a of the end part 17 and the bore 12 of the roller body 11. The end cap 17a of the end part 17 comprises a cylindrical body 17b and an end portion 17c extending outward from the cylindrical body 17b. The second annular sealing element 20 is radially interposed between the cylindrical body 17b of the end part 17 and the bore 12 of the roller body 11 and axially interposed between the end portion 17c of the end cap 17a of the end part 17 and the bore 12 of the roller body 11.

A first end 17d of the cylindrical body 17b of the end cap 17a of the end part 17 is secured to a second end 14c of the tubular housing 14c of the sensor module 14. The cylindrical body 17b of the end cap 17a of the end part 17 may be clipped on the end 14c of the tubular housing 14a of the sensor module 14. A groove 17e is formed on the cylindrical body 17b of the end cap 17a of the end part 17. The second annular sealing element 20 is located partly inside the groove 17e.

The device 13 as a whole is shaped to fit within the roller bore 12, and is mounted to and located in the bore 12 by means of the first and second sealing elements 19, 20.

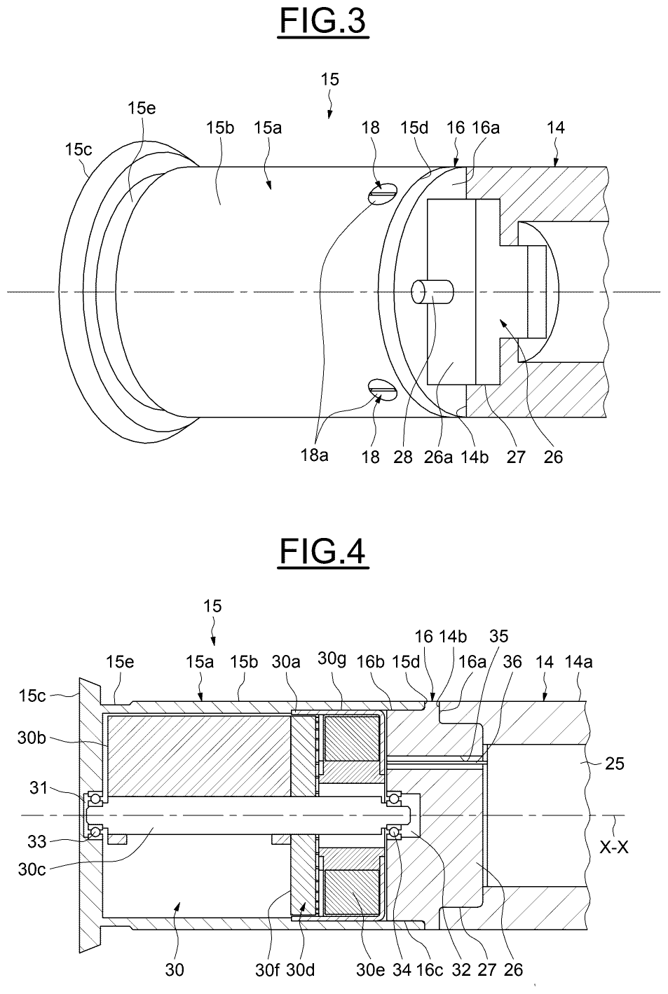

FIGS. 3 and 4 illustrate respectively a partial view and a longitudinal cross section of an example of the sensor module 14 and the power module 15. The sensor and antenna housed in the sensor module 14 are represented on FIG. 4 and referenced 25.

The first end 14b of the sensor module 14 further comprises an aperture 27 having a complementary shape of the projection 26. The non-circular projection 26 is inserted into the non-circular aperture 27 to avoid a rotation of the tubular housing 14a of the sensor module 14 relative to the adapter 16. The non-circular part 26 may be rectangular, triangular, square, hexagonal, star shaped or another shape so that the adapter 16 does not rotate relative the tubular housing 14a of the sensor module 14.

The device 13 further comprises securing means to axially secure the adapter 16 and the first end 14b of the tubular housing 14a of the sensor module 14. The securing means comprises at least first and second pins 28, 29 supported by the non-circular part 26. A first end of the first pin 28 is inserted into a first lateral face 26a of the non-circular part 26 and a first end of the second pin 29 being inserted into a second lateral face 26b of the non-circular part 26. The second lateral face 26b of the non-circular part 26 is opposed to the first lateral face 26a of the non-circular part 26.

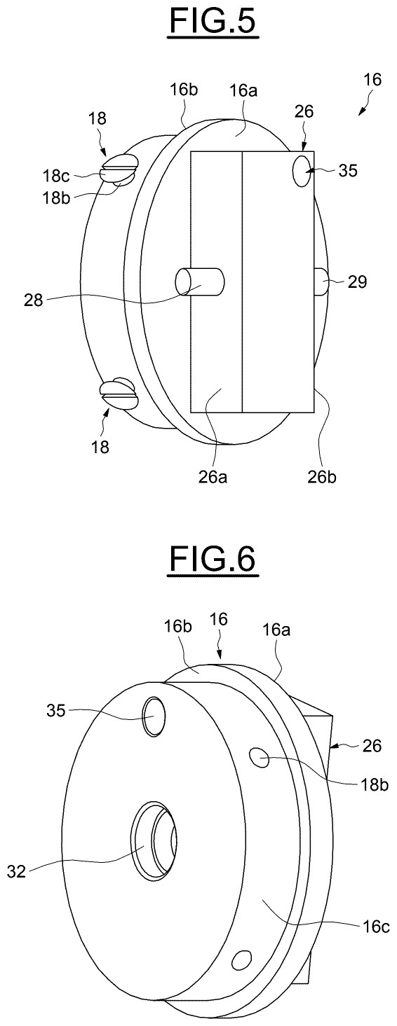

The second end of the first and second pins 28, 29 is inserted into the tubular housing 14a of the sensor module 14. The second pin 29 and the second lateral face 26b of the rectangular part 26 are represented in FIG. 5.

The power module 15 may house an energy harvester. The energy harvester comprises for example an electrical generator 30 having an axis along a longitudinal axis X-X of the hollow sensorized roller 10. The electrical generator produces energy using the rotation of the hollow sensorized roller 10.

The electrical generator 30 comprises a stator 30a rigidly fixed to the cylindrical body 15b of the housing 15a of the power module 15, an eccentric mass or weight 30b rigidly fixed to a main shaft 30c having an axis along the first axis X-X, a rotor 30d fixed to the shaft 30c and a stator coil 30e mounted in the stator 30a and configured to be rotated by the rotation of the hollow sensorized roller 10. The stator coil 30e forms one single stator pole. The rotor 30d comprises a magnetic ring 30f comprising for example permanent magnets.

The eccentric mass 30b is driven by gravity G and centrifugal force to maintain the main shaft 30c of the generator 30 when rotation of the hollow sensorized roller 10 along the first rotation axis X-X. The rotation of the hollow sensorized roller drives the rotation of the stator 30a and thus the stator coil 30e of the generator 30. The stator 30a is located axially between the rotor 30d and the mounting base 16b.

The stator 30 may comprise flux guides 30g encompassing the rotor 30d to guide the magnetic flux. The passage of the magnetic ring 30f in front of the flux guides 30g generates an electromotive force between the ends of the coil 30e. The power generated by the electric generator 30 depends on the magnetic flux going through the coil 30e. The flux guides 30g concentrate and guide the magnetic flux of the rotor 30d through the stator coil 30e of the stator 30a so that the stator coil 30e generates a higher electromotive force. The flux guides 30g redirect axially all the magnetic flux of the magnetic ring 30f so that the magnetic flux passes through the stator coil 30e.

The electrical generator 30 is a claw pole generator. In variant, the electrical generator 30 may comprise a plurality of stator poles, the generator 30 being for example a multi-pole brushless DC electric motor BLDC. The electrical generator 30 may be another kind of generator.

The end cap 15c of the housing 15a of the power module 15 includes a first bore 31 housing a first bearing 33 and the mounting base 16b of the adapter 16 has a second bore 32 housing a second bearing 34 rotatably supporting the main shaft 30c of the electrical generator 30.

The first and second bearings 33, 34 limit axial and radial displacements of the main shaft 30c thereby reducing the airgap between the magnetic ring 30f and the flux guides 30g.

The limitation of the axial and radial displacements of the main shaft 30c further prevents collisions between the magnetic ring 30f and the flux guides 30g and prevents collisions between the eccentric mass 30b and the tubular housing 15a of the power module 15. The bearings 33, 34 may comprise deep groove ball bearings.

The adapter 16 further comprises an axial through-hole 35 inside which a wire 36 passes through to electrically connect the power module 15 and the sensor module 14. As the power module 15 and the sensor module 14 are secured together in such a manner that the power module 15 cannot rotate compared with the sensor module 14, the wire 32 cannot be damaged.

The end cap 15c of the housing 15a may be conical. Similarly, the end portion 17c of the end cap 17a of the end part 17 may be conical.

FIGS. 5 and 6 illustrate views of the example of adapter 16 illustrated in FIGS. 3 and 4. The mounting base 16b of the adapter 16 comprises a circumferential surface 16c onto which is mounted the housing 15a of the power module 15. The fixing means 18 comprise a first set of through-holes 18a in a lateral face of the housing 15a of the power module 15 (represented in FIG. 3), a second set of holes 18b in the circumferential surface 16c and a plurality of screws 18c. Each screw 18c passes through one of the through-holes 18a of the first set and being engaged in one of the holes 18b of the second set.

The adapter 16 permits to robustly secure the power module 15 to the sensor module 14 in a removable manner and to simplify the mounting of the hollow sensorized roller 10.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved sensorized rolling elements.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A device configured to be mounted in an axial central through bore of a hollow sensorized roller, the device comprising:
a sensor module, a power module and an adapter connecting the power module and the sensor module,
wherein the sensor module comprises a tubular housing and the power module comprising a housing,
wherein the adapter has a central portion in axial contact with a first end of the tubular housing of the sensor module and a mounting base onto which is mounted the housing of the power module and a non-circular projection extending from the central portion,
wherein the non-circular projection extends into a complementary opening in the tubular housing of the sensor module to prevent relative rotation of the housing of the sensor module relative to the adapter.

2. The device according to claim 1, further comprising securing means configured to axially secure the adapter to the tubular housing of the sensor module.

3. The device according to claim 2,
wherein the securing means comprises at least first and second pins, a first end of a first pin being inserted into a first lateral face of the non-circular projection and a first end of a second pin being inserted into a second lateral face of the non-circular projection, the second lateral face being opposed to the first lateral face, the second end of the first and second pins being inserted into the tubular housing of the sensor module.

4. The device according to claim 1, further comprising fixing means to secure the mounting base to the housing of the power module.

5. The device according to claim 4,
wherein the mounting base of the adapter comprises a circumferential surface onto which is mounted the housing of the power module,
wherein the fixing means comprises a first set of through-holes in a lateral face of the housing of the power module, a second set of holes in the circumferential surface and a plurality of screws, each screw passing through one of the through-holes of the first set and being engaged in one of the holes of the second set.

6. The device according to claim 1,
wherein the adapter includes an axial through-hole, and
wherein the power module is electrically connected to the sensor module by a wire passing through the through-hole.

7. The device according to claim 1,
wherein an end cap of the power module includes an opening and a first bearing in the opening,
wherein the mounting base of the adapter includes an opening and a second bearing in the opening of the mounting base of the adapter, and
wherein a support shaft of the power module is rotatably supported by the first bearing and the second bearing.

8. A hollow sensorized roller for a rolling bearing comprising a roller body having an axial central through bore and a device according to claim 1 mounted in the axial central bore of the roller body.

9. A rolling bearing comprising:
a stationary first ring,
a rotatable second ring configured to rotate concentrically relative to the first ring, and
at least one row of rollers interposed between a first raceway of the first ring and a second raceway of the second ring,
wherein one of the rollers is a hollow sensorized roller according to claim 1.
